(19) United States
(12) Patent Application Publication
(10) Pub. No.: US 2025/0136469 A1
(43) Pub. Date: May 1, 2025

(54) FILTERING UNIT WITH TWO OR MORE STAGES WITH ENGAGING PORTIONS

(71) Applicant: LAICA S.P.A., Barbarano Mossano (IT)

(72) Inventors: Franco UVA, Lonigo (IT); Enrico BARBERO, Pressana (IT)

(21) Appl. No.: 18/730,103

(22) PCT Filed: Jan. 20, 2023
(86) PCT No.: PCT/IB2023/050514

§ 371 Date: Jul. 18, 2024

(30) Foreign Application Priority Data
Jan. 20, 2022 (IT) 102022000000932

(51) Int. Cl. C02F 1/00

(52) U.S. Cl. CPC C02F 1/003; C02F 2201/003; C02F 2303/04; C02F 2307/04

(57) ABSTRACT

A filtering unit with two stages which comprises a main body which is subdivided into a first section comprising in turn a first filter and a second section comprising in turn a second filter; a coupling system for the second filter in turn comprising an external covering; a fluid-tight seal which separates the first section and second section. The coupling system prevents the movement of the second filter when it is fixed in a working position thereof and allows the fluid-tight seal to isolate the two sections without any risk of contamination.

The present invention relates to a filtering unit for water with two or more filtration stages, generally known as the filter cartridge. Normally, this filter cartridge is used in devices for producing hot drinks, such as, for example, kettles and/or coffee machines or in various types of domestic devices for water treatment, such as, for example, filtering jugs, water dispensers, tap filters, filtering flasks, coffee machines.

The purpose of filtering water and in general improving its flavour, results from different requirements and in some cases from contingent requirements. For example, the main purpose of the filter cartridges intended for devices for dispensing coffee is to eliminate the limescale which is present in the water in order to preserve the device from damage caused by the limescale deposits. Other requirements result, for example, from the need to eliminate from mains water the chlorinating substances which are used for disinfection and for making the water drinkable, these substances in fact being unpleasant to smell and generally making the taste of the water worse. However, other filtering systems act on the so-called heavy metals, such as lead or copper, but still others are investigated specifically in order to enrich the water with magnesium ions in place of calcium ions. In some cases, particularly where the water network does not ensure adequate levels of security in terms of potability, there is set out the need for using so-called POU filtering systems (point of use) which are capable of carrying out an antibacterial action. Another problem may be constituted by the presence of so-called microplastics in tap water. A large number of tests in fact show that very many people drink daily drinking water which is seriously contaminated to a greater or lesser extent by particles or microparticles of plastics material, the results of which on the organism are unknown at present, which results in the need to carry out a mechanical filtration of the drinking water with systems which are capable of treating the microplastics particles to the greatest possible extent.

In the context of this requirement, there have been developed a number of solutions which are directed towards configuring the filtering units so as to allow the user to purify the water, associating with a single filter cartridge one or more solutions in order to comply with the requirements cited above more extensively.

An example of a filter cartridge is described in the Chinese utility model CN203513390 which relates to a filtering element in two stages, the first stage is composed by a mixture of ion exchange resin and activated carbon in order to reduce the hardness and the chlorine a and second antibacterial sterilization stage. The filter element which constitutes the second stage is of the type using a membrane for ultra-filtration or micro-filtration.

It is generally evident that the second filtration stage, in order to be effective, has to be assembled in such a manner that there cannot occur leakage phenomena between the two stages, that is to say, all the liquid necessarily has to pass through the membrane filter. In order to ensure this, there are normally provided suitable fluid-tightness systems, such as, for example, O-ring seals or over-moulded seals.

The seals can be integral with the body of the antibacterial filter and are naturally positioned so as to engage with the relevant walls of the filtering unit.

However, the Applicant has found that, in the event of accidental impacts or imprecise assembly, the correct separation is not ensured between the first portion and the second portion of the filtering unit as a result of movements or incorrect positioning of the seal.

As mentioned above, the absence of the division between the two portions nullifies the presence of the second filtration stage which acts as an antibacterial filter. Consequently, if the water passes from the first portion to the second portion of the filtering unit without passing through the second filter, the water remains contaminated with the bacteria which are present and makes the presence of the filtering unit dangerously useless.

Therefore, the problem addressed by the present invention is to provide a filtering unit with two stages which allows one or more of the disadvantages set out with reference to the cited prior art to be at least partially overcome.

An object of the present invention is to provide a filtering unit with two stages, in which it is possible to maintain the division between a first portion of the filtering unit, in which a first filter acts, and a second portion, in which a second antibacterial filter acts, allowing the user to obtain drinkable water with optimum organoleptic properties as a product of the filtration.

Another object of the invention is to provide a filtering unit which achieves the above object, is easy to construct and is economical.

According to a first aspect of the invention, this problem is solved and these objects are achieved by a filtering unit with two stages as specified above, which comprises a main body which is subdivided into a first section comprising a first filter and a second section comprising a second filter; a coupling system for the second filter comprising an external covering; a fluid-tight seal which separates the first section and second section.

Preferably, the coupling system comprises a plurality of engaging portions which are configured to be connected to respective seats. Preferably, the engaging portions and the seats being formed on the external covering of the second filter and on the main body, respectively, or vice versa, so as to define an abutment between the second filter and the main body so as to prevent a movement of the second filter at least in a mutually approaching direction between the first filter and the second filter, allowing the fluid-tight seal to isolate the two sections without any risk of contamination. In other words, the coupling system is configured in such a manner that, when the plurality of engaging portions are coupled with the respective seats, movement of the second filter is prevented at least in an approach direction between the first filter and the second filter.

The main advantage of the invention is that the presence of the coupling system ensures the correct positioning of the second filter so that the fluid-tight seal ensures the division between the first section and second section and prevents contaminations between the water, which still contains bacteria, and the drinking water being discharged from the second filter. Furthermore, the coupling system allows the correct positioning of the second filter also to be maintained in the event of impacts because it mechanically blocks the external covering, preventing movements thereof.

It will be appreciated that, in the context of the present invention, the term “abutment” between two bodies, such as the engaging portions and the respective members, indicates a contact between respective surfaces of these bodies.

This contact specifically limits t relative movements between engaging portions and seats and therefore between the first filter and second filter, thereby obtaining the above-described effect.

Preferably, the main body has a substantially cylindrical form and comprises a central axis thereof. The main body extends between an upper end thereof and a lower end thereof. Preferably, both ends are partially perforated in order to allow the introduction and discharge of the water and the passage thereof through the second filter.

The terms “upper” and “lower”, “above” and “below”, “high” and “low” are intended to be understood in accordance with the direction of gravitational force.

The substantially cylindrical form of the main body may taper near the lower end so as to facilitate the blocking of the second filter in the coupling system and to promote the fluid-tight seal in the division of the two sections.

According to a number of preferred embodiments of the invention, each engaging portion of the plurality of engaging portions extends from the main body towards the central axis thereof, reducing the distance from the central axis in the downward direction. Preferably, each engaging portion has a triangular cross-section. Preferably, the cross-section is in the form of a right-angled triangle with the 90° angle being in the region of the main body of the filtering unit, at the side of the engaging portion which is proximal to the lower end of the filtering unit.

Preferably, the plurality of engaging portions are connected to the seats which are formed on the external covering of the second filter; the second filter is in a working position once the external covering has been connected to the engaging portions.

Preferably, the plurality of engaging portions are three engaging portions which are spaced apart from each other by approximately 120°.

The external covering comprises, for example, a cylindrical body with a lower edge which projects with respect to the cylindrical body and a fluid-tight seal which is integral therewith and which projects with respect to the cylindrical body.

According to a number of preferred embodiments of the invention, the lower edge extends in the manner of a collar around the external covering and the seats are defined in the lower region by the lower edge and in the upper region by the seal.

Preferably, the lower edge, in the proximal portion with respect to the lower end of the filtering unit, extends from the external covering towards the main body in an upward direction with a gradient counter to the gradient of the plurality of engaging portions.

In this manner, in an insertion step of the second filter, in the filtering unit, the opposing gradients between the engaging portions and the lower edge facilitate the introduction of the second filter and the mechanical fixing thereof.

Preferably, the abutment is defined by means of contact between an upper surface of the lower edge which preferably delimits the seat and a lower surface of the engaging portions.

Preferably, the lower surface corresponds to one of the sides of the triangular shape of the section of the engaging portions. Advantageously, the insertion step can also be promoted by a given capacity for resilient deformation of the engaging portions.

Preferably, the first filter is a filter for improving the organoleptic properties of water and can be selected from an activated carbon filter and an ion exchange resin filter. In some embodiments, the second filter is an antibacterial filter with hollow fibres.

Preferably, the engaging portions project in the main body. In some embodiments, the engaging portions project inside the main body towards the central axis.

Preferably, the engaging portions are configured so as to fix a portion of the external covering of the second filter in addition to the engaging portions when the second filter is inserted inside the main body.

Another advantage of the invention involves the construction simplicity, in fact a second aspect of the present invention relates to an assembly method for a filtering unit according to the invention which provides for inserting the second filter in the main body and urging it until it resiliently deforms the engaging portions so as to fix a portion of the external covering of the second filter in addition to the engaging portions and to prevent the movement of the second filter inside the main body.

While the second filter is being inserted, it is positioned in such a manner that the fluid-tight seal is received between the main body and the external covering of the second filter So as to make two portions of the filtering unit non-communicating with each other except for through the second filter.

Subsequently, the first filter is introduced and finally the filtering unit is closed with the upper end which is non- removable.

As a result of this structure, the filtering unit provides a first purification stage which is brought about in the first portion and in which the organoleptic properties of the water to be purified are improved, and a second stage, which is brought about in the second portion and in which the water is purged of the bacteria present, making the water purified.

These features and the advantages associated therewith will also be better understood from the detailed description of a number of preferred embodiments of the invention which will be illustrated by way of non-limiting example with reference to the appended drawings, in which:

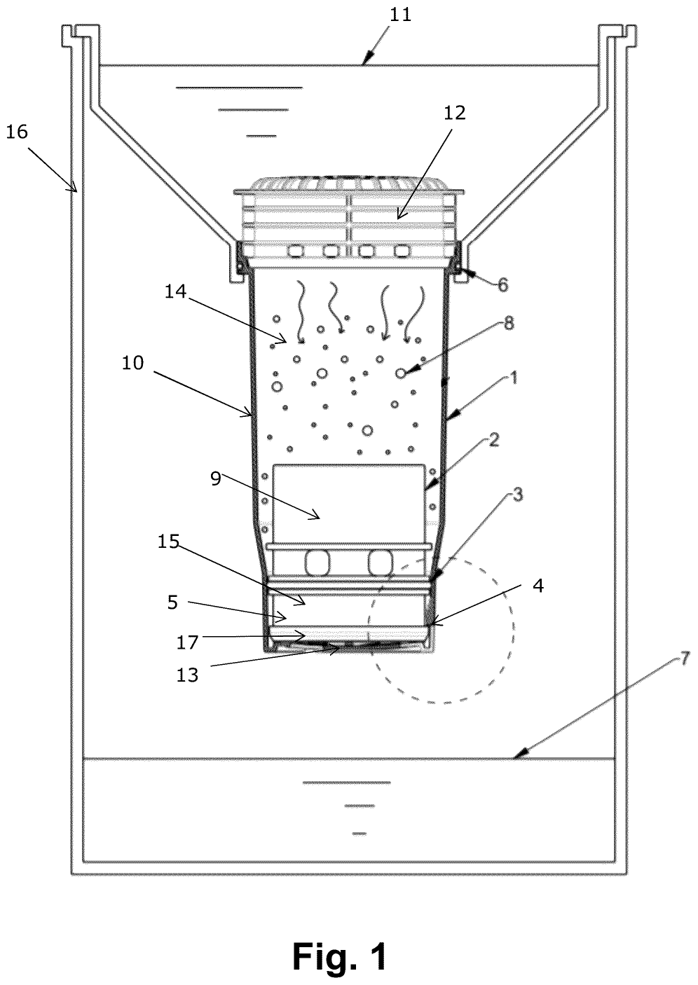

FIG. 1 is a side view of the filtering unit to which the invention relates and which is installed in a filtering jug;

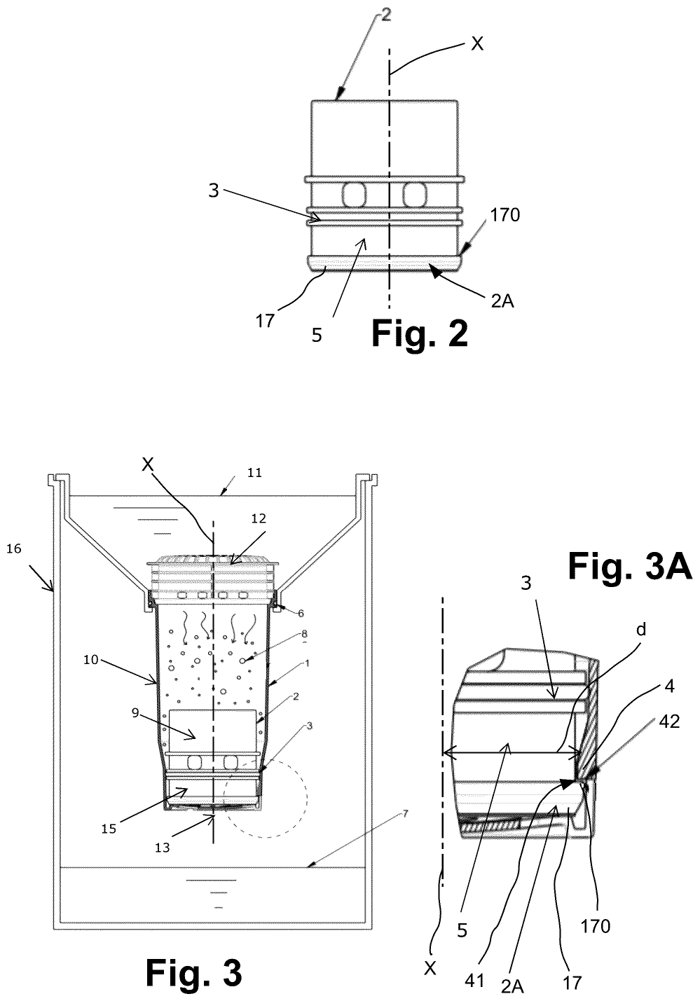

FIG. 2 is a side view of a second filter of the filtering unit of FIG. 1; and

FIGS. 3 and 3A are a side view and a detail of the filtering unit of FIG. 1 and a relevant detail.

With reference to the Figures, there is illustrated a preferred embodiment of a filtering unit which is generally designated 1.

The filtering unit 1 with two stages comprises a main body 10 which is subdivided into a first section 14 comprising in turn a first filter 8 and a second section 15 comprising in turn a second filter 9.

As illustrated in FIG. 1, in some embodiments the filtering unit 1 may be installed in a filtering jug 16 and is mechanically fixed in the jug 16 via a divider element 6 (hopper) which subdivides the jug 16 into two zones: a first zone which contains the water 11 to be purified and a second zone which is intended to contain the purified water 7 once it has passed through the filtering unit.

In the present context, the term “purified water 7” is intended to be understood to be drinking water or more generally water, the characteristics of which have been made more suitable or pleasant for consumption by a user.

Water 11 to be purified is intended to be understood to be water which can contain harmful ionic substances, impurities and where applicable bacteria.

Advantageously, the isolating element 6 ensures that there are no contaminations between the water 11 to be purified and the purified water 7 and that the water 11 to be purified reaches the second zone of the purified water 7 only by passing through the filtering unit 1 with two stages.

In some embodiments, the main body 10 has a substantially cylindrical shape and comprises a central axis thereof. Preferably, the main body extends between an upper end 12 thereof and a lower end 13 thereof. Both ends 12, 13 can be partially perforated in order to allow the flow of water through the filtering unit 1 with two stages, with the water 11 to be purified which is introduced from the upper end 12 and the purified water 7 which is discharged from the lower end 13.

The terms “upper” and “lower” are intended to be understood to be in accordance with the direction of gravitational force. The filtering unit 1 also comprises a coupling system of the second filter 9 and a fluid-tight seal 3 which separates the first section 14 and the second section 15. According to the embodiment set out in the Figures, the coupling system comprises a plurality of engaging portions 4 (FIG. 3) which are configured to connect to respective seats 5, the engaging portions 4 and the seats 5 being formed on the main body 10 and on the external covering of the second filter 9, respectively, so as to define an abutment between the second filter 9 and the main body 10 so as to prevent a movement of the second filter 9 at least in an approach direction between the first filter 8 and the second filter 9, allowing the fluid-tight seal 3 to isolate the two sections 14, 15 without any risk of contamination.

Still according to preferred embodiments, such as, for example, the one set out in the Figures, the coupling system comprises three engaging portions 4 which extend from the main body 10 towards the central axis X, reducing the distance d from the central axis in a downward direction. Substantially, each engaging portion 4 has a section in the form of a right-angled triangle with the angle of 90° being in the region of the main body 10 of the filtering unit 1 at the side of the engaging portion 4 which is proximal to the lower end 13 of the filtering unit 1.

Preferably, the engaging portions 4 are connected to the respective seats 5 which are formed on the external covering 2 of the second filter 9; the second filter 9 is located in a working position once the external covering 2 has been connected to the engaging portions 9.

In some embodiments, there are three engaging portions and they are preferably spaced apart from each other by 120°.

The external covering 2, in order to be able to be connected to the engaging portions 4, preferably comprises a cylindrical body with a lower edge 17 which projects with respect to the cylindrical body.

In some embodiments, the lower edge 17 extends in the manner of a collar around the external covering 2 and the seats 5 are also defined in a continuous manner along the external covering 2 and they are delimited in the lower region by the lower edge 17 and in the upper region by the seal 3, as may be observed in the example illustrated in FIG. 3.

It will be appreciated that the seats 5, being continuously defined along the external covering 2, can be formed by different regions of a single seat, each region being intended to form a respective seat for an engaging portion 4.

According to another aspect, the lower edge 17 in the portion proximal to the lower end 13 of the filtering unit 1 extends from the external covering 2 towards the main body 10 in an upward direction with a gradient counter to the gradient of the plurality of engaging portions 4.

In this manner, in an insertion step of the second filter 9, in the filtering unit 1, the opposing gradients between the engaging portions 4 and the lower edge 17 facilitate the introduction of the second filter 9 and the mechanical fixing thereof.

Advantageously, the insertion step can also be promoted by a given capacity for resilient deformation of the engaging portions 4.

Advantageously, in the assembly step, when the second filter 9 is introduced inside the filtering unit 1 the second filter 9 is urged towards the lower end 15 of the filtering unit 1 and, by resiliently deforming the engaging portions 4, the lower edge 17 becomes mechanically fixed, ensuring that the second filter 9 takes up and maintains the working position thereof.

In fact, there is defined an abutment 41 by means of contact between an upper surface 170 of the lower edge which delimits the seat 5 and a lower surface 42 of the engaging portions 4. The lower edge 17 thereby defines a portion 2A of the external body 2 of the second filter which can be interlocked with the engaging portions 4, defining the abutment 41.

According to the preferred embodiment illustrated in the Figures, the fluid-tight seal 3 is integral with the external covering 2 of the second filter 9 in a position higher than the lower edge 17.

In this manner, when the second filter 9 takes up the working position thereof, it positions the fluid-tight seal 3 so as to divide the first section 14 and second section 15 of the filtering unit 1, ensuring that there is no contamination between the water 11 to be purified and the purified water 7.

Furthermore, the filtering unit 1 comprises a tapering near the lower end 13 of the main body 10, facilitating the receiving of the fluid-tight seal 3.

In preferred embodiments, the first filter 8 is an ion exchange resin filter.

Preferably, the second filter 9 is an antibacterial filter with hollow fibres.

As anticipated, once the second filter 9 is inserted in the filtering unit 9 with two stages, it is in a working position, the fluid-tight seal 3 is also correctly positioned and the assembly of the filtering unit 1 continues by inserting the first filter 8 and finally by closing the filtering unit 1 with the removable upper end 12.

As a result of this structure, the filtering unit 1 provides a first purification stage, in which the organoleptic properties of the water 11 to be purified are improved, and a second stage, in which the water is purged of the bacteria present, making it purified water 7.

In order to comply with additional and contingent requirements, a person skilled in the art may apply to the above-described filtering unit 1 with two stages and the relevant method for use a number of additional modifications and variants which are all still included within the scope of protection of the present invention as defined by the appended claims.

1-19. (canceled)

20. A filter cartridge with two stages, including:
a main body which is subdivided into a first section comprising a first filter and a second section comprising a second filter, wherein said main body extends between an upper end and a lower end, wherein said upper end and said lower end are both partially perforated, said upper end being configured so as to close the main body in a non-removable manner, the filter cartridge being configured such that water to be purified is introduced from the upper end and purified water is discharged, in accordance with the direction of gravity, from the lower end, the first filter comprising an activated carbon filter and/or an ion exchange resin filter, the second filter comprising an antibacterial filter with hollow fibers;
a coupling system for the second filter comprising an external covering;
a fluid-tight seal which separates the first section and second section;
the coupling system comprising a plurality of resiliently deformable engaging portions which are configured to be connected to respective seats, the engaging portions and the seats being formed on the external covering of the second filter and on the main body, respectively, or vice versa, so as to define an abutment between the second filter and the main body, said abutment between engaging portions and the respective seats preventing a movement of the second filter at least in a mutually approaching direction between the first filter and the second filter, allowing the fluid-tight seal to isolate the two sections without any risk of contamination.

21. A filter cartridge according to claim 20, wherein the coupling system is configured in such a manner that, when the plurality of engaging portions is coupled with the respective seats, the movement of the second filter is prevented in the approach direction between the first filter and the second filter.

22. A filter cartridge according to claim 20, wherein the main body has a substantially cylindrical form and comprises a central axis thereof.

23. A filter cartridge according to claim 22, wherein each engaging portion of the plurality extends from the main body towards the central axis thereof, reducing a distance thereof from the central axis in the downward direction.

24. A filter cartridge according to claim 23, wherein each engaging portion of the plurality has a triangular cross-section.

25. A filter cartridge according to claim 24, wherein the cross-section is in the form of a right-angled triangle with an angle of 90° being positioned in the region of the main body of the filter cartridge, at a side of the engaging portion which is proximal to the lower end of the main body.

26. A filter cartridge according to claim 20, wherein the engaging portions are connected to the external covering of the second filter, the second filter being in a working position once the external covering has been connected to the engaging portions.

27. A filter cartridge according to claim 20, comprising three engaging portions which are spaced apart from each other by approximately 120°.

28. A filter cartridge according to claim 20, wherein the seats are defined by a lower edge which is formed on the external covering, the lower edge projecting with respect to the external covering.

29. A filter cartridge according to claim 28, wherein the lower edge, in a proximal portion thereof with respect to the lower edge, extends from the external covering towards the main body in an upward direction, with a gradient counter to the gradient of the plurality of engaging portions.

30. A filter cartridge according to claim 28, wherein the abutment is defined by means of contact between an upper surface of the lower edge and a lower surface of the engaging portions.

31. A filter cartridge according to claim 30, wherein the upper surface delimits the seats.

32. A filter cartridge according to claim 20, wherein the fluid-tight seal projects with respect to the external covering.

33. A filter cartridge according to claim 32, wherein the external covering is a cylindrical member.

34. A filter cartridge according to claim 22, wherein the substantially cylindrical form of the main body tapers near the lower end thereof.

35. A filter cartridge according to claim 20, wherein the main body is configured to be able to be installed in a filtering jug.

36. A filter cartridge according to claim 20, wherein the engaging portions are configured so as to fix a portion of the external covering of the second filter beyond the engaging portions when the second filter is inserted in the main body.

37. A filter cartridge according to claim 20, wherein the engaging portions project in the main body.

38. An assembly method for a filter cartridge with two stages, comprising a main body which is subdivided into a first section in turn comprising a first filter and a second section in turn comprising a second filter, the filter cartridge also comprising a coupling system for the second filter in turn comprising an external covering, wherein the coupling system comprises a plurality of engaging portions which extend from the main body towards each other, the method comprising:
inserting the second filter in the main body and urging it until it resiliently deforms the engaging portions so as to fix a portion of the external covering of the second filter in addition to the engaging portions and to prevent the movement of the second filter inside the main body, wherein said second filter comprises an antibacterial filter with hollow fibres;
inserting the second filter by positioning it in such a manner that a fluid-tight seal is received between the main body and the external covering of the second filter so as to make the two portions of the filter cartridge non-communicating with each other except for through the second filter;
introducing the first filter in an upper position respect to the second filter, wherein said first filter comprises an activated carbon filter and/or an ion exchange resin filter; and
closing the main body with an upper end which is partially perforated and is configured so as to close the main body in a non-removable manner.
